(19) United States
(12) Patent Application Publication
(10) Pub. No.: US 2019/0126692 A1
(43) Pub. Date: May 2, 2019

(54) PNEUMATIC TIRE WITH IMPROVED VIBRATION CHARACTERISTICS

(71) Applicant: Ford Global Technologies, LLC, Dearborn, MI (US)

(72) Inventors: Arne Boden, Moenchengladbach (DE); David Scott Rohweder, Troy, MI (US); Arne Heyden, Cologne (DE)

(73) Assignee: Ford Global Technologies, LLC, Dearborn, MI (US)

(21) Appl. No.: 16/179,200

(22) Filed: Nov. 2, 2018

(30) Foreign Application Priority Data
Nov. 2, 2017 (DE) 10 2017 219 520.7

(51) Int. Cl. B60C 15/06; B60C 15/05

(52) U.S. Cl. CPC B60C 15/0628; B60C 2015/042; B60C 15/05

(57) ABSTRACT

A pneumatic tire has modified dimensions and/or materials characteristics and is designed and constructed for use in place of a conventional, standards-meeting tire of a standards-meeting tire/rim combination. The rim has a bead seat with an outer diameter established by a standards-setting organization to mate with a conventional tire. The modified pneumatic tire has a bead of an inner diameter established by: a) determining a conventional radial force exerted by the bead of the conventional tire on the rim, and b) setting the inner diameter such that, when mounted on the rim the bead exerts on the bead seat a modified radial force between 5% and 25% lower than the conventional radial force.

### CROSS-REFERENCE TO RELATED APPLICATIONS

This application claims foreign priority benefits under 35 U.S.C. § 119(a)-(d) to DE Application 10 2017 219 520.7 filed Nov. 2, 2017, which is hereby incorporated by reference in its entirety.

### TECHNICAL FIELD

The present invention relates to a pneumatic tire for use on a motor vehicle, and to such a tire having a design that is modified to improve noise-causing tire vibrations.

### BACKGROUND

Such tire/rim arrangements are known from a plurality of designs. In very general terms, the bead core has the object of securing a stable seat of the pneumatic tire on the wheel rim. In this case, the fulfillment of two opposing demands has to be taken into account in principle, namely on one hand to ensure sufficient strength of the tire seat on the rim for the operating loads which occur during travel with a motor vehicle, for example, as a result of transverse forces acting on the tire during cornering and as a result of moments of force acting on the tire during braking/acceleration processes, and on the other hand to enable sufficiently easy mounting of the tire on the rim, in the case of which the tire bead also must not suffer any damage.

By way of example, US 2009/0025848 A1 (also EP 1 776 248 B1), which discloses in particular a configuration of a tire bead for a pneumatic tire which is suitable in particular for use on heavy goods vehicles, is cited for the description of a known tire/rim arrangement.

In recent vehicle development, in addition to the above-mentioned criteria to be taken into account in the case of tire/rim arrangements, there has also been an ever-greater focus on the desire for a reduction in driving noises which occur during driving operation of a vehicle and are perceived by users of the vehicle in a vehicle interior as a quality feature and competitive advantage.

In particular the transmission of structure-borne noise between a pneumatic tire which is caused to vibrate during driving operation and a wheel rim on which the pneumatic tire is fitted plays a significant role in the transmission of driving noise into a vehicle interior. The structure-borne noise passes from the wheel rim via a wheel suspension, to which the rim is connected, to the vehicle structure, from where it can be perceived by a vehicle occupant as structure-borne noise (vibrations) and/or as airborne noise emitted into the vehicle interior.

In particular those vibrations which can be perceived in a vehicle interior and which occur in a frequency range from approximately 60 Hz to approximately 300 Hz are to be understood in this case as relevant structure-borne noise. This frequency range can be divided into three sub-ranges, wherein one frequency between approximately 60 Hz and approximately 125 Hz can be perceived by a vehicle occupant as low-frequency noise, a frequency between approximately 125 Hz and approximately 200 Hz as high-frequency noise and a frequency between approximately 200 Hz and approximately 300 Hz as what is known as cavity noise.

Attempts have already been made to reduce the transmission of noise from tire/rim arrangements, for example, by the use of additional damping masses, additional noise absorbers or by reducing the radial stiffness of the pneumatic tire, which can lead, however, to a deterioration of the tire rolling resistance and/or to losses in terms of driving performance (e.g. during steering).

### SUMMARY

Against this background, the object on which the present invention is based is to create an arrangement comprising a pneumatic tire and a wheel rim, onto which the pneumatic tire is fitted, for a vehicle, in particular motor vehicle, which significantly reduces a transmission of structure-borne noise from pneumatic tire caused to vibrate during driving operation of the vehicle on the wheel rim holding it in comparison with tire/rim arrangements known from the prior art and as a result also the vibrations and/or driving noises which can be perceived by a vehicle occupant in the interior of the vehicle. It should furthermore be possible to realize the tire/rim arrangement with structurally simple means and simultaneously overcome the above-mentioned disadvantages of the prior art.

The features listed individually in the following description can be combined with one another in any desired, technically expedient manner and highlight further configurations of the invention. The description characterizes and specifies the invention in particular additionally in conjunction with the figures.

According to the invention, there is provided an arrangement comprising a pneumatic tire and a wheel rim, onto which the pneumatic tire is mounted, for a vehicle, in particular motor vehicle, in the case of which the pneumatic tire has a running surface which forms a transition on both sides into side walls, the ends of which are formed in each case by a tire bead which is inserted in each case in an air-tight manner in a bead seat, which is delimited axially by a rim flange and a hump, of the rim so that an air cavity filled with compressed air can be formed between the rim and the pneumatic tire. In the case of the arrangement according to the invention, the inner diameter, which is defined by the radial inner side of each tire bead, of the pneumatic tire is of such larger dimensions than the outer diameter, which is defined by the radial outer side of the corresponding bead seat, of the rim and/or the elasticity of each tire bead in the circumferential and/or radial direction of the corresponding bead seat is fixed in such a manner that the radial force exerted by each tire bead on the corresponding bead seat, in the case of a pneumatic tire filled with operating air pressure, is at least approximately 5% lower than in the case of a conventional pneumatic tire which can be conventionally assigned to the previously determined wheel rim.

The hump of the wheel rim is a circumferential elevation, which is known per se in the case of conventional wheel rims, on the rim shoulder to prevent the tire bead from slipping into the drop center of the rim in the case of low pressure. The rim flange represents the axially outermost or axially innermost delimitation of the wheel rim so that the bead seat is formed between the rim flange and the hump which is spaced apart axially therefrom. The radial inner side of the tire bead is the side of the corresponding tire bead which bears against the bead seat or bead seat base. The operating air pressure of the pneumatic tire is the air pressure of the pneumatic tire specified for the intended use of the vehicle, for example, by the manufacturer.

The inventors have discovered, to their surprise, that a transmission of structure-borne noise from the pneumatic tire, which is caused to vibrate during driving operation of the vehicle, to the wheel rim via the tire bead and the bead seat is particularly reduced if the radial force of the tire bead on the bead seat, in the case of a pneumatic tire filled with operating air pressure, is at least approximately 5% smaller than in the case of a conventional pneumatic tire which can be assigned conventionally to the previously determined wheel rim, i.e. than in the case of a conventional or standardized tire/rim arrangement (also referred to herein as a standard tire/rim arrangement). It should be noted here that measurable fluctuations of a radial force of two different standardized tire/rim arrangements with otherwise the same nominal dimensions of the pneumatic tire and the wheel rim, which are caused in particular by production-induced size deviations of the pneumatic tire and/or the wheel rim, which, however, all lie within the manufacturing tolerances specified for the respective manufacturing method of the standard/conventional pneumatic tire and/or the wheel rim, are by far not large enough to fall into the range of the radial force disclosed here and reduced according to the invention by at least 5% in comparison with the radial force acting in the case of a conventional tire/rim arrangement and consequently are also not covered by the definition according to the invention.

The inventors have furthermore discovered that a transmission of structure-borne noise between the pneumatic tire and the wheel rim occurs via the tire bead and the bead seat to a significantly higher extent if the radial force of the tire bead on the bead seat of the wheel rim is significantly higher, i.e. at least 5%, above the previously defined value according to the invention. The inventors have furthermore ascertained that, in the case of standardized or conventional tire/rim arrangements (standards-meeting tire/rim combinations), i.e. in the case of a standards-meeting pneumatic tire assigned conventionally to a respective standards-meeting wheel rim, the radial force of the tire bead on the bead seat of the wheel rim always lies in a range which significantly facilitates a transmission of structure-borne noise from the pneumatic tire to the wheel rim.

Conventional assignments of a pneumatic tire to a wheel rim with certain size dimensions within the meaning of the present invention are specified by the guidelines and norms drawn up by the respectively known technical organizations. Such technical organizations include, for example, the ETRTO (European Tire and Rim Technical Organisation), TRA (Tire and Rim Association), JATMA (Japan Automobile Tire Manufacturers Association) and the like. Within the meaning of the present invention, “a standards-meeting pneumatic tire which can be assigned conventionally to the previously determined standards-meeting wheel rim” should correspondingly be understood as a tire/rim arrangement (also referred to herein as a standards-meeting tire/rim combination) which is determined from a combination of a conventional pneumatic tire (standard pneumatic tire) with a previously determined, conventional wheel rim (standard wheel rim) in accordance with the generally known guidelines and norms (as established by standards-setting organizations that are recognized and accepted by the automotive industry, for example) for such (conventional) tire/rim combinations.

The reduction according to the invention of the radial force by at least 5% with respect to a radial force of a conventional tire/rim arrangement means that a tire/rim arrangement according to the invention can have a radial force which is, for example, 5% or 6% or 7% or 8% or 9% or 10% etc. below that of a conventional tire/rim arrangement in order to achieve the transmission of structure-borne noise, which is reduced within the meaning of the invention, between the pneumatic tire and the wheel rim of a tire/rim arrangement according to the invention in such a manner that a vehicle occupant perceives a clear improvement in travelling comfort during driving operation of the vehicle in comparison with the use of a conventional tire/rim arrangement on the vehicle, i.e. perceives significantly reduced vibrations and/or driving noise in the vehicle interior caused by the tire/rim arrangement. At the same time, the present invention also, however, avoids the above-mentioned disadvantages of the prior art, for example, a deterioration in tire rolling resistance or inferior driving properties since no other properties of the pneumatic tire are changed apart from the parameter(s) inner diameter of the pneumatic tire to the outer diameter of the tire rim and/or elasticity of the tire bead in relation to the bead seat. The present invention likewise dispenses with the use of additional components, for example, damping masses and/or sound absorbers and can therefore be realized with structurally simple means.

According to one advantageous configuration of the invention, the above-mentioned parameter(s), for example, inner diameter of the pneumatic tire to the outer diameter of the tire rim and/or elasticity of the tire bead in the bead seat is/are dimensioned in such a manner that the radial force exerted by each tire bead on the corresponding bead seat, in the case of a pneumatic tire filled with operating air pressure, is at most approximately 25% lower than in the case of a conventional pneumatic tire which can be conventionally assigned to the previously determined wheel rim, i.e. than in the case of a conventional tire/rim arrangement.

According to the above-mentioned embodiment, the radial force of the tire/rim arrangement according to the invention therefore advantageously lies in the range between a maximum of approximately 25% (lower threshold value) and at least approximately 5% (upper threshold value) below a radial force of a conventional tire/rim arrangement. In other advantageous configurations, this reduction can also be set, for example, in a range between at least approximately 5% and at most approximately 20% or at least approximately 10% and at most approximately 25% or also at least approximately 10% and at most approximately 20% and also all range combinations which are conceivable within this meaning between at least approximately 5% and at most approximately 25%.

The lower threshold value ensures, despite the advantage of a reduced transmission of structure-borne noise between the pneumatic tire and the wheel rim, a solid seat of the pneumatic tire on the wheel rim for all operating loads during operation of the vehicle. In particular, adherence to the low threshold value particularly advantageously prevents the tire bead itself jumping out of its bead seat into the drop center of the wheel rim even in the case of an air pressure in the pneumatic tire below or significantly below the recommended operating air pressure (low pressure) as a result of the operating loads during operation of the vehicle, would result in a rapid loss in the total air pressure retained in the pneumatic tire.

A further advantageous configuration of the invention provides that the wheel rim corresponds to a conventional or standardized rim with a conventional or standardized rim diameter and only the pneumatic tire is modified in comparison with a conventional/standardized pneumatic tire which can be conventionally assigned to the previously determined standardized wheel rim (standard-meeting pneumatic tire) as defined above. Since, in the case of the configurations of the present invention described herein, at least for the parameter inner diameter of the pneumatic tire to the outer diameter of the wheel rim, an adjustment of the outer diameter of the wheel rim in comparison with a conventional wheel rim which can conventionally be assigned to the previously determined pneumatic tire is only or additionally possible, according to this configuration of the invention, only the pneumatic tire is advantageously changed in comparison with a conventional pneumatic tire which can be conventionally assigned to the previously determined wheel rim (standards-meeting pneumatic tire) within the meaning of the present invention in order to reduce the transmission of structure-borne noise from the pneumatic tire to the wheel rim as described herein. The present configuration of the invention thus permits the use of a standard rim with a conventional rim diameter to which only the pneumatic tire used of the tire/rim arrangement according to the invention is correspondingly adapted in the manner described herein. This configuration is significantly easier to realize than a corresponding adjustment of the wheel rim or even both components, namely the wheel rim and the pneumatic tire.

According to a yet further configuration of the invention, the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, an inner diameter, defined by the radial center of the bead core, i.e. radially to the outside, of the bead core being formed to be larger in comparison with a conventional pneumatic tire which can conventionally be assigned to the previously determined wheel rim (standard pneumatic tire).

The center of the bead core in relation to its extent in the radial direction of the pneumatic tire is to be understood as the radial center of the bead core. Moreover, within the meaning of the present invention, the relative term “larger” used above is to be interpreted so that size deviations, which are a result of production, in the inner diameter of the bead bore which lie within the manufacturing tolerances defined for the respective production method are not covered by the relative term “larger” or “smaller” used herein. In other words, according to the above definition, an inner diameter of a bead core of a tire bead is only to be regarded as “larger” or “smaller” within the meaning of the present invention than an inner diameter of a bead core of a comparative tire bead if the two compared inner diameters differ from one another in terms of their size to such an extent that this difference in size certainly no longer falls into the tolerance range, which arises as a result of production, of the inner diameter of the respective bead cores.

In the case of an otherwise unchanged material thickness of the arranged rubber material between the bead core and the radial inner side of the tire bead, the entire tire bead including bead core and core profile according to the above configuration in accordance with its enlarged inner diameter consequently also defines a larger inner diameter of the pneumatic tire than in the case of conventional pneumatic tire which can be conventionally assigned to the previously determined wheel rim. As a result of a defined increase in the inner diameter of the pneumatic tire in comparison with an outer diameter, which remains constant, of the previously determined wheel rim, the radial force of the tire bead on the bead seat of the wheel rim is reduced in such a manner that it is smaller at least by approximately 5% in comparison with a radial force of a conventional tire/rim arrangement. The increase in the inner diameter of the bead core is preferably restricted in this case such that the radial force is at most approximately 25% smaller in comparison with the radial force of the conventional tire/rim arrangement.

Alternatively to the increase in size described above of the inner diameter of the pneumatic tire, in the case of a further advantageous configuration of the invention, the radial thickness of the rubber material which is arranged between the radially innermost steel cords and the radial inner side of the tire bead can, in the case of a bead core described above with an increased inner diameter in comparison with a radial thickness of the rubber material between the bead core and the radial inner side of a pneumatic tire of a conventional tire/rim arrangement, also be formed to be larger. In this case, the radial thickness is selected so that the inner diameter of the pneumatic tire remains constant overall despite the increase in size of the inner diameter of the bead core.

Within the meaning of the present invention, the relative term “larger” used above is to be interpreted so that size deviations, which are a result of production, in the radial thickness of the stated rubber material which lie within the manufacturing tolerances defined for the respective production method are not covered by the relative term “larger” or “smaller” used herein. In other words, according to the above definition, a radial thickness of a rubber material between the bead core and the radial inner side of a pneumatic tire is only to be regarded as “larger” or “smaller” within the meaning of the present invention than a radial thickness of a rubber material of a comparative tire bead if the two compared thicknesses differ from one another in terms of their size to such an extent that this difference in size certainly no longer falls into the tolerance range, which arises as a result of production, of the radial thicknesses of the respective stated rubber materials.

It has been shown that such an increase in the radial thickness of the rubber material between the bead core and the radial inner side of the pneumatic tire also leads to a damping of the transmission of structure-borne noise from the pneumatic tire to the wheel rim, onto which it is fitted, as a result of a reduction in the radial force of the tire bead on the bead seat of the tire rim in such a manner that this radial force, in the case of a corresponding increase in the inner diameter of the bead core and the associated increase in the radial thickness of the rubber material between the bead core and the radial inner side of the tire bead, is at least approximately 5% smaller in comparison with a radial force of a conventional tire/rim arrangement. The increase in the inner diameter of the bead core or the increase in the radial thickness of the stated rubber material is preferably restricted in this case in such a manner that the radial force is at most approximately 25% smaller in comparison with the radial force of the conventional tire/rim arrangement.

According to a yet further advantageous configuration of the invention, the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, the number of steel cords of the bead core being lower in comparison with a conventional pneumatic tire which can conventionally be assigned to the previously determined wheel rim (standard pneumatic tire). The reduction in the number of steel cords in the bead core leads to an increase in the flexibility or elasticity of the tire bead in the circumferential direction of the bead seat and thus to a reduction in the radial force of the tire bead on the bead seat of the wheel rim. The reduction in the number of steel cords in the bead core or the increase in flexibility or elasticity of the bead core in the circumferential direction of the bead seat is carried out in this case such that the radial force on the bead seat of the wheel rim is at least approximately 5% smaller in comparison with a radial force of a conventional tire/rim arrangement. The reduction in the number of steel cords in the bead core is in this case restricted in such a manner that the radial force is at most approximately 25% smaller than the radial force of the conventional tire/rim arrangement.

A further advantageous configuration of the invention provides that the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, the diameter (material diameter) of at least a part of the steel cords of the bead core being formed to be smaller in comparison with a conventional pneumatic tire which can conventionally be assigned to the previously determined wheel rim (standard pneumatic tire).

Within the meaning of the present invention, the relative term “smaller” used above is to be interpreted so that size deviations, which are a result of production, in the diameter of the steel cords which lie within the manufacturing tolerances defined for the respective production method of the steel cord are not covered by the relative term “larger” or “smaller” used herein. In other words, according to the above definition, a diameter of a steel cord is only to be regarded as “larger” or “smaller” within the meaning of the present invention than a diameter of a comparative steel cord if the two compared material diameters differ from one another in terms of their size to such an extent that this difference in size certainly no longer falls into the tolerance range, which arises as a result of production, of the diameter of the respective steel cord.

The reduction in the diameter of at least a part of the steel cord which forms the bead core also increases the flexibility or elasticity of the tire bead in the circumferential direction of the bead seat and thus leads to a reduction in the radial force of the tire bead on the bead seat of the wheel rim. The reduction in the diameter of at least a part of the steel cord in the bead core or the selection of the number of steel cords with reduced diameter in the bead core in order to increase the flexibility or elasticity of the bead core in the circumferential direction of the bead seat is carried out in this case such that the radial force on the bead seat of the wheel rim is at least approximately 5% smaller in comparison with a radial force of a conventional tire/rim arrangement. The reduction in the diameter of at least a part of the steel cord which forms the bead core is preferably restricted in this case in such a manner that the radial force is at most approximately 25% smaller than the radial force of the conventional tire/rim arrangement.

A yet further advantageous configuration of the invention provides that the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, the elasticity of at least a part of the steel cords of the bead core being formed to be greater in comparison with a conventional pneumatic tire which can conventionally be assigned to the previously determined wheel rim (standard pneumatic tire).

Within the meaning of the present invention, the relative term “higher” used above is to be configured so that size deviations, which are a result of production, in the elasticity of the steel cords which lie within the manufacturing tolerances defined for the respective production method of the steel cords are not covered by the relative term “higher” or “lower” used herein. In other words, according to the above definition, an elasticity of a steel cord is only to be regarded as “higher” or “lower” within the meaning of the present invention than an elasticity of a comparative steel cord if the two compared elasticities differ from one another in terms of their size to such an extent that this difference in size certainly no longer falls into the tolerance range, which arises as a result of production, of the elasticity of the respective steel cords.

The increase in the elasticity of at least a part of the steel cords which form the bead core and run in the circumferential direction of the bead seat leads to a reduction in the radial force of the tire bead on the bead seat of the wheel rim. In this case, the selection of the material with increased elasticity or the selection of the number of more elastic steel cords in the bead core in order to increase the flexibility or elasticity of the bead core in the circumferential direction of the bead seat is carried out in such a manner that the radial force on the bead seat of the wheel rim is at least approximately 5% smaller in comparison with a radial force of a conventional tire/rim arrangement. The increase in the elasticity of at least a part of the steel cords which form the bead core is preferably restricted in this case in such a manner that the radial force is at most approximately 25% smaller in comparison with the radial force of the conventional tire/rim arrangement.

According to a yet further advantageous configuration of the invention, the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, a rubber material which is provided between the radially innermost steel cord and the radial inner side of the tire bead and which surrounds the bead core radially on the inside rotationally symmetrically with respect to the axial axis of the pneumatic tire having a higher elasticity in comparison with a conventional pneumatic tire which can conventionally be assigned to the previously determined wheel rim (standard pneumatic tire), in particular in the radial direction of the pneumatic tire. For example, this rubber material which also forms in particular the tire seat on the tire rim can have a lower density and thus less material in the same volume or be a rubber material with a lower modulus of elasticity so that it has overall a higher elasticity which leads at least to an increase in the radial elasticity of the tire bead in relation to the bead seat and thus to a reduction in the radial force of the tire bead on the bead seat of the wheel rim.

Within the meaning of the present invention, the relative term “higher” used above is to be configured so that size deviations, which are a result of production, in the elasticity of the stated rubber material which lie within the manufacturing tolerances defined for the respective production method of the rubber are not covered by the relative term “higher” or “lower” used herein. In other words, according to the above definition, an elasticity of a rubber material is only to be regarded as “higher” or “lower” within the meaning of the present invention than an elasticity of a comparative steel cord if the two compared elasticities differ from one another in terms of their size to such an extent that this difference in size certainly no longer falls into the tolerance range, which arises as a result of production, of the elasticity of the respective rubber material.

The higher elasticity of the rubber material between the bead core and the radial inner side, which bears against the bead seat, of the tire bead is selected in such a manner in this case that the radial force on the bead seat of the wheel rim is at least approximately 5% smaller in comparison with a radial force of a conventional tire/rim arrangement. The increase in the elasticity of the stated rubber material is preferably restricted such that the radial force is at most approximately 25% smaller in comparison with the radial force of the conventional tire/rim arrangement.

According to a yet further configuration of the invention, the tire bead has a bead core, which has in cross-section a plurality of steel cords, and a core profile, which encloses the bead core in a rotationally symmetrical manner with respect to the axial axis of the pneumatic tire. At least one carcass ply is wrapped around the bead core with the core profile, a rubber material which is provided between the radially innermost steel cord and the radial inner side of the tire bead and which surrounds the bead core radially on the inside rotationally symmetrically with respect to the axial axis of the pneumatic tire having a smaller radial thickness in comparison with a conventional pneumatic tire which can conventionally be assigned to the previously determined wheel rim (standard pneumatic tire), wherein the thickness of the rubber material in the radial direction of the pneumatic tire is to be understood as the radial thickness.

Within the meaning of the present invention, the relative term “smaller” used above is to be configured so that size deviations, which are a result of production, in the thickness of the stated rubber material which lie within the manufacturing tolerances defined for the respective production method of the rubber material are not covered by the relative term “smaller” or “larger” used herein. In other words, according to the above definition, a thickness of a rubber material is only to be regarded as “smaller” or “larger” within the meaning of the present invention than a thickness of a comparative rubber material if the two compared thicknesses differ from one another in terms of their size to such an extent that this difference in size certainly no longer falls into the tolerance range, which arises as a result of production, of the thickness of the respective rubber material.

In the case of an otherwise unchanged inner diameter of the bead core, the entire tire bead including bead core, core profile and stated rubber material between the bead core and the radial inner side of the tire bead according to the above configuration in accordance with the reduced thickness of the rubber material consequently also defines a larger inner diameter of the pneumatic tire than in the case of conventional pneumatic tire which can be conventionally assigned to the previously determined wheel rim. As a result of a defined increase in the inner diameter of the pneumatic tire in comparison with an outer diameter, which remains constant, of the wheel rim, the radial force of the tire bead on the bead seat of the wheel rim is reduced in such a manner that it is smaller at least by approximately 5% in comparison with a radial force of a conventional tire/rim arrangement. The increase in the inner diameter of the bead core is preferably restricted in this case such that the radial force is at most approximately 25% smaller in comparison with the radial force of the conventional tire/rim arrangement.

It should be understood that the various configurations of the invention described above can also be combined with one another as desired in order to specify the parameters inner diameter of the pneumatic tire to the outer diameter of the wheel rim and/or elasticity of the tire bead in the circumferential and/or radial direction of the bead seat of the wheel rim in the manner described herein.

A further advantageous configuration of the invention provides that the wheel rim is an extended hump rim. The extended hump rim, for which the designations EH2 and EH2+ are also used, is characterized by a higher hump in comparison with a non-extended hump rim. In other words, the bead seat, which is delimited in the axial direction of the wheel rim laterally by the rim flange and the hump, provides the extended hump rim with an even better seat or retention of the tire bead, received in the bead seat, of the tire/rim arrangement according to the invention, which yet further reduces the risk of the tire bead slipping into the drop center of the wheel rim particularly in the case of low air pressure in the pneumatic tire.

Further features and advantages of the invention will become apparent from the following description of exemplary embodiments which are not to be understood in a restrictive manner and which are explained in greater detail below with reference to the drawing. In this drawing, schematically:

### BRIEF DESCRIPTION OF THE DRAWINGS

FIG. 1 is a cross-sectional partial view of an exemplary embodiment of a tire/rim arrangement according to the invention,

FIG. 2A is an enlarged cross-sectional view of a tire bead of a conventional pneumatic tire;

FIG. 2B is an enlarged cross-sectional view of a tire bead of a pneumatic tire of an exemplary embodiment of a tire/rim arrangement according to the invention,

FIG. 3A is a cross-sectional view of the tire bead of the conventional tire bead from FIG. 2A;

FIG. 3B is an enlarged cross-sectional view of a tire bead of a pneumatic tire of a further exemplary embodiment of a tire/rim arrangement according to the invention;

FIG. 4A is a cross-sectional view of the tire bead of the conventional tire bead from FIG. 2A; and

FIG. 4B is an enlarged cross-sectional view of a tire bead of a pneumatic tire of a yet further exemplary embodiment of a tire/rim arrangement according to the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the various figures, equivalent parts are always provided with the same reference numbers in terms of their function so that these are generally also only described once.

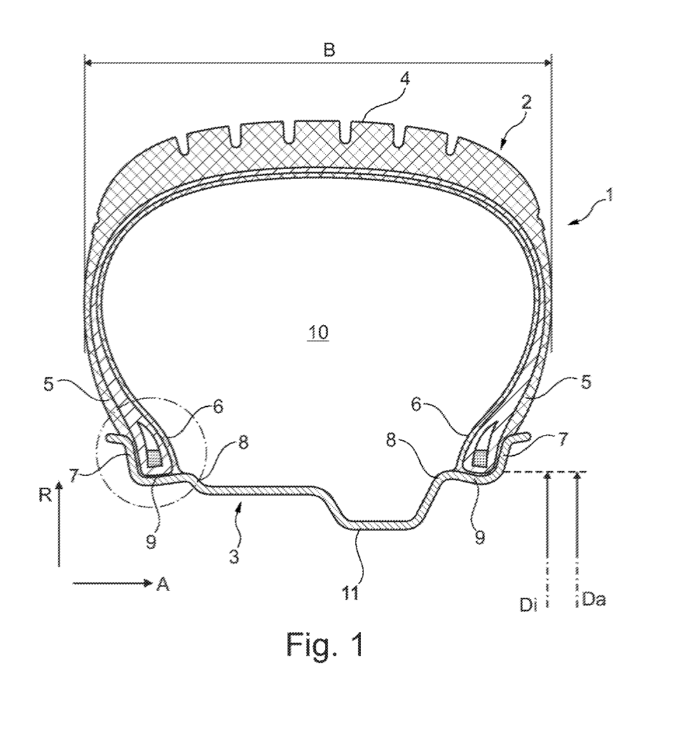

FIG. 1 schematically represents a cross-sectional partial view of an exemplary embodiment of a tire/rim arrangement 1 according to the invention. The sectional plane of the representation runs in this case parallel to an axial or rotational axis, not represented in FIG. 1, of arrangement 1, wherein only the upper half of tire/rim arrangement 1 can be seen in FIG. 1. The running direction of the axial axis of arrangement 1 is indicated in FIG. 1 by an arrow designated by A, a radial direction of arrangement 1 by the designation R.

As is apparent in FIG. 1, arrangement 1 is formed from a pneumatic tire 2 and a wheel rim 3 on which pneumatic tire 2 is fitted. Tire/rim arrangement 1 represented in FIG. 1 forms a vehicle wheel for a motor vehicle, not shown in greater detail, for example, a car. The tire/rim arrangement according to the invention is not, however, generally restricted to use on cars. Other single-track or multi-track vehicle types, for example, motorcycles, heavy goods vehicles and the like, are also conceivable.

It is further apparent from FIG. 1 that pneumatic tire 2 has, on its radial outer side, a running surface 4 which is profiled or structured in the represented case. Running surface 4 forms a transition on both sides into side walls 5, the ends of which are formed in each case by a tire bead 6 which is inserted in each case in an air-tight manner in a bead seat 9, which is delimited axially by a rim flange 7 and a hump 8, of rim 3 so that an air cavity 10 filled with compressed air can be formed between rim 3 and pneumatic tire 2.

Rim 3 furthermore has a drop center 11 of the type well known in the pertinent technical fields.

Inner diameter Di of pneumatic tire 2 is defined by the radial inner side of tire bead 6. The radial outer side of corresponding bead seat 9 defines outer diameter Da of rim 3. In the representation of FIG. 1, it is not possible to differentiate between these two diameters Di and Da since pneumatic tire 2 is represented fitted on wheel rim 3. Inner diameter Di of pneumatic tire 2 and outer diameter Da of wheel rim 3 are correspondingly delimited by a common delimitation line in the representation of FIG. 1. It should, however, be understood that both variables Di and Da can differ in terms of numbers.

Pneumatic tire 2 represented in FIG. 1 furthermore has a nominal tire width B. The tire width of the pneumatic tire conventionally declared for each pneumatic tire (for example, by the tire manufacturer) should be understood as nominal tire width B.

Pneumatic tire 2 and wheel rim 3 of arrangement 1 represented in FIG. 1 are formed at their points of contact, i.e. at tire bead 6 and/or at bead seat 9, in such a manner that the radial force generated by each tire bead 6 on corresponding bead seat 9 is, in the case of pneumatic tire 2 filled with operating air pressure, at least approximately 5% lower than in the case of a conventional pneumatic tire which can be conventionally assigned to previously determined wheel rim 3, i.e. than in the case of a conventional tire/rim arrangement. However, at the same time, said radial force in the case of arrangement 1 represented in FIG. 1 can also be dimensioned so that it is at most approximately 25% lower than in the case of a conventional pneumatic tire which can be conventionally assigned to previously determined wheel rim 3, i.e. than in the case of a standard tire/rim arrangement.

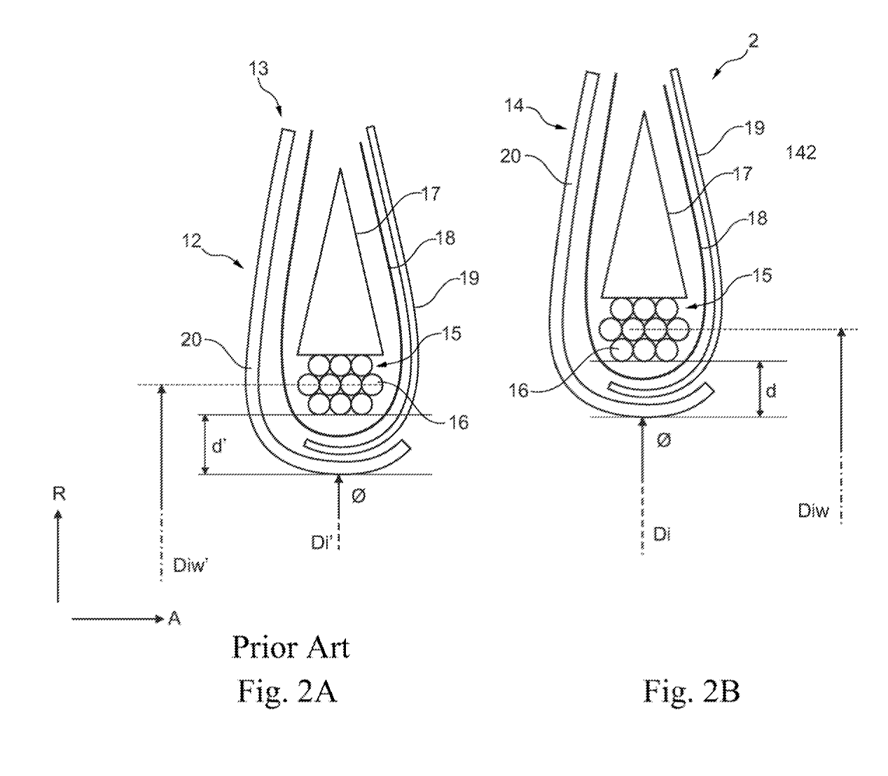

FIG. 2 schematically represents in view (a) an enlarged cross-sectional view of a tire bead 12 of a conventional pneumatic tire 13 (standard pneumatic tire) and in view (b) an enlarged cross-sectional view of a tire bead 14 of pneumatic tire 2 shown in FIG. 1 of an exemplary embodiment of a tire/rim arrangement, not shown entirely in FIG. 2, according to the invention. The cut-out of respective pneumatic tire 2, 13 represented in views (a) and (b) of FIG. 2 corresponds to the point marked by a dashed circle in FIG. 1. The following description correspondingly relates only to one of the two tire beads 14, 12 of pneumatic tire 2 or 13, but equally also applies to respective other tire bead 14, 12 of the same pneumatic tire 2 or 13.

A pneumatic tire 13 (standards-meeting pneumatic tire) assigned to the previously determined standards-meeting wheel rim, not represented in FIG. 2, their actual size dimensions according to the generally known guidelines, for example, ETRTO, TRA, JATMA etc., is to be understood as conventional pneumatic tire 13 represented in view (a) of FIG. 2.

As is apparent from FIG. 2 both in view (a) and in view (b), both tire bead 12 and tire bead 14 have in each case a bead core 15 which has in cross-section a plurality of steel cords 16 arranged substantially hexagonally in the case of the exemplary embodiment shown (hexagonal bead core configuration), and a core profile 17 which encloses bead core 16 rotationally symmetrically with respect to the axial axis of pneumatic tire 2 or 13. Core profile 17, which can also be referred to as an apex, can be composed, for example, of a rubber mixture.

A carcass inlay 18 which is wound around respective bead bore 15 including core profile 17 (e.g. mono-ply tire construction) is furthermore apparent in FIG. 2 on both tire beads 12, 14. In other embodiments, not represented, more than one carcass inlay 18 can also be wound around bead core 16 and core profile 17 (e.g. dual-ply tire construction). Carcass inlay 18 transmits the forces in pneumatic tire 2, 13 to tire beads 14 or 12 in a manner known per se.

Tire bead 14 or 12 according to the representation in FIG. 2 furthermore has an inner coating or inner liner 19 which is normally formed as a rubber ply for sealing off pneumatic tire 2, 14 or air cavity 10 (FIG. 1). Pneumatic tires 2, 13 in FIG. 2 also have an outer tire wall 20, for example, what is known as a “rim strip” which, after the arrangement of pneumatic tire 2, 13 on rim 3 represented in FIG. 1, bears against respective rim flange 7.

The following description of both views (a) and (b) of FIG. 2 is based on the same wheel rim with identical dimensions, in particular an identical outer or rim diameter. This wheel rim corresponds in this example to a standard rim with standard dimensions.

As is apparent in FIG. 2A, conventional pneumatic tire 13 has an inner diameter Di′ defined by the distance of the radial inner side of tire bead 12 from the center point of the tire (not visible in FIG. 2). An inner diameter Diw′ of bead core 15 is defined by the distance of the radial center of steel cords 16 forming bead core 15 to the center point of the tire, not represented, as can also be inferred from FIG. 2A. Moreover, in FIG. 2A, a thickness (radial thickness) of a rubber material arranged between radially innermost steel cords 16 of bead core 15 and the radial inner side of tire bead 12 is designated by d′ (rubber thickness). Stated rubber material surrounds bead core 15 radially on the inside rotationally symmetrically to the axial axis of pneumatic tire 13.

The variables inner diameter Di of pneumatic tire 2, inner diameter Diw of bead core 15 and rubber thickness d of the rubber material arranged between radially innermost steel cords 16 of bead core 15 and the radial inner side of tire bead 14 are correspondingly defined in FIG. 2B.

It is clear from the representation of tire bead 14 in FIG. 2B that both inner diameter Di of pneumatic tire 2 defined by the radial inner side of tire bead 14 and inner diameter Diw of corresponding bead core 15 are formed to be larger in comparison with standards-meeting pneumatic tire 13 of FIG. 2A. Rubber thicknesses d′ of tire bead 12 and d of tire bead 14 are formed to be of substantially the same size in the case of the exemplary embodiment represented in FIG. 2. In the case of an identical wheel rim for both pneumatic tires 2 and 13, pneumatic tire 2 of FIG. 2B or tire bead 14 thereof exerts a small radial force on the bead seat of the corresponding wheel rim, for example, bead seat 9 of wheel rim 3 in FIG. 1, in comparison with pneumatic tire 13 of FIG. 2A. Tire beads 14 and 12 have substantially identical structures apart from their different inner diameters Diw, Di or Diw′, Di′. Inner diameter Di of pneumatic tire 2 or inner diameter Diw of bead core 15 of tire bead 14 are in this case increased in size in comparison with conventional pneumatic tire 13 in such a manner that the radial force exerted by each tire bead 14 of pneumatic tire 2 on corresponding bead seat 9 (FIG. 1), in the case of pneumatic tire 2 filled with operating air pressure, is at least approximately 5% smaller than in the case of a conventional pneumatic tire 13, represented in FIG. 2A, which can be assigned conventionally to previously determined wheel rim 3. The size of inner diameter Di of pneumatic tire 2 or of inner diameter Diw of bead core 15 of tire bead 14 is, however, simultaneously also restricted at the top in such a manner that the radial force of tire bead 14 on bead seat 9 of wheel rim 3 is at most approximately 25% smaller than in the case of a conventional pneumatic tire 13, represented in FIG. 2A, which can be assigned conventionally to previously determined wheel rim 3.

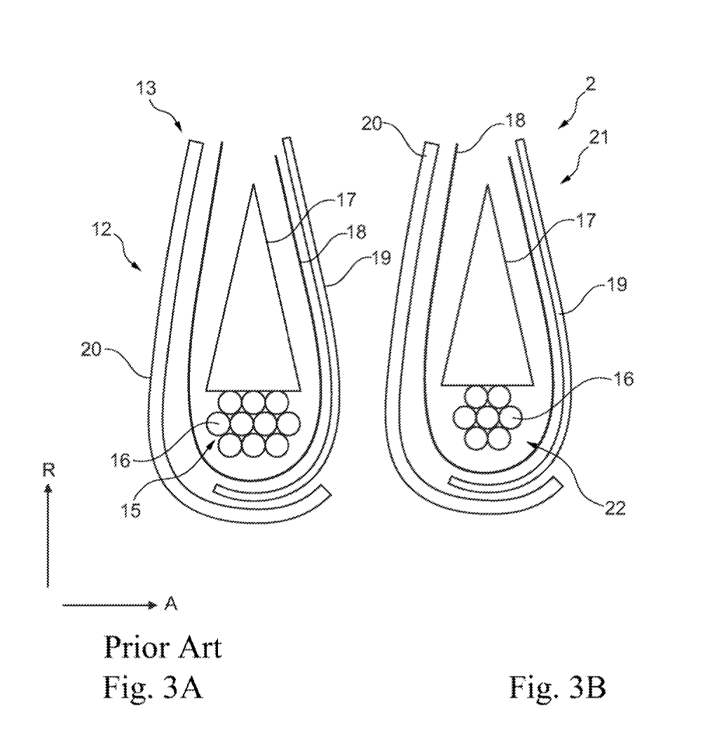

FIG. 3 represents schematically in view (a) the cross-sectional view of tire bead 12 of conventional pneumatic tire 13 from FIG. 2A and in view (b) an enlarged cross-sectional view of a tire bead 21 of pneumatic tire 2 shown in FIG. 1 of a further exemplary embodiment of a tire/rim arrangement, not shown fully in FIG. 3, according to the invention.

As can be inferred from a comparison of both views (a) and (b) of FIG. 3, the difference between tire beads 12 and 21 lies substantially in the number of steel cords 16 which form bead core 15 or 22. Bead core 15 in pneumatic tire 13 of the prior art has, by way of example, 10 steel cords 16 which are arranged in a 3-4-3 arrangement of a hexagonal bead core configuration. In contrast, bead core 22 of pneumatic tire 2 has a total of 7 steel cords 16 which are arranged in a 2-3-2 arrangement of an also hexagonal bead core configuration. The smaller number of steel cords 16 in tire bead 21 is dimensioned in such a manner here that the radial contact force exerted by each tire bead 21 of pneumatic tire 2 on corresponding bead seat 9 (FIG. 1), in the case of the modified pneumatic tire 2 filled with operating air pressure, is approximately 5% smaller than in the case of a conventional pneumatic tire 13, represented in FIG. 3a, which can be assigned conventionally to previously determined wheel rim 3. The smaller number of steel cords 16 in bead core 22 of tire bead 21 is, however, simultaneously also restricted at the bottom in such a manner that the radial force of tire bead 21 on bead seat 9 of wheel rim 3 is at most approximately 25% smaller than in the case of a conventional pneumatic tire 13, represented in FIG. 3a, which can be assigned conventionally to previously determined wheel rim 3. The special (in this example, hexagonal) arrangement of steel cords 16 in bead core 22 offers an additional possibility of positively influencing the transmission of force from tire bead 21 onto corresponding bead seat 9 of wheel rim 3 (FIG. 1) within the meaning of the present invention.

It should be noted that, in addition to the number of steel cords 16 in bead core 22, additionally or alternatively, their elasticity of at least a part of steel cords 16 of bead core 22 can also be increased by selecting a material with different material properties in order to achieve a similar effect to that described above. Additionally or alternatively, the diameter of individual steel cords 16 of at least a part of bead core 22 could also be formed to be smaller in order to also achieve the effect described above.

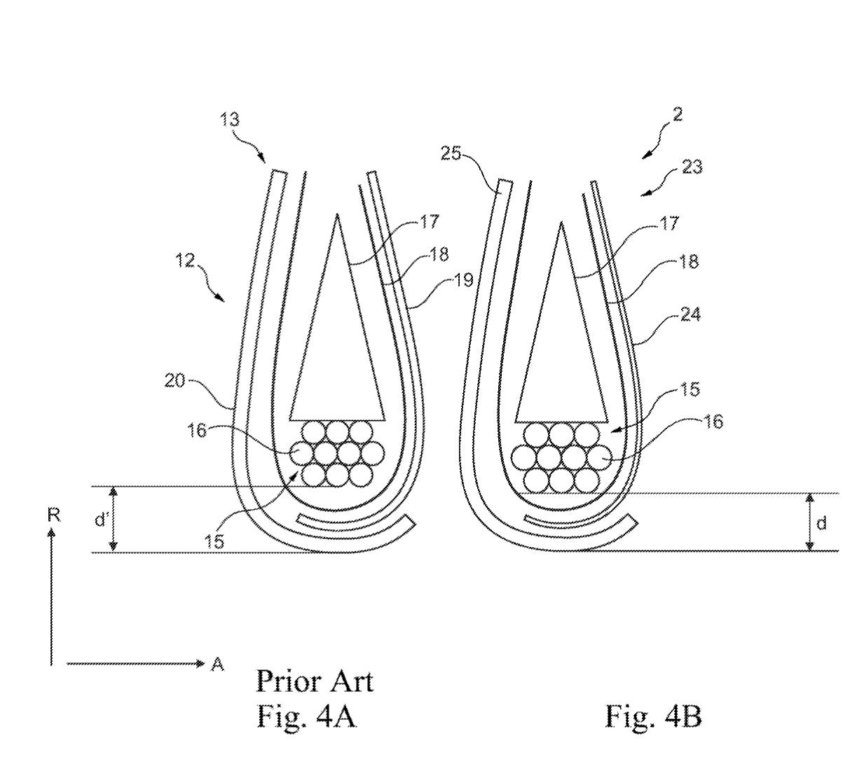

FIG. 4 represents schematically in view (a) the cross-sectional view of tire bead 12 of conventional pneumatic tire 13 from FIG. 2A and in view (b) an enlarged cross-sectional view of a tire bead 23 of pneumatic tire 2 shown in FIG. 1 of a further exemplary embodiment of a further exemplary embodiment of a tire/rim arrangement, not shown fully in FIG. 4, according to the invention.

As can be inferred from a comparison of both views (a) and (b) of FIG. 4, the difference between tire beads 12 and 23 lies substantially in a smaller thickness d in the case of tire bead 23 in comparison with tire bead 12 of the rubber material which is located between radially innermost steel cords 16 and the radial inner side of tire bead 23 which bears against bead seat 9 of wheel rim 3 (FIG. 1), in comparison with thickness d′ of the rubber material of tire bead 12 of conventional pneumatic tire 13 represented in FIG. 4a. In the case of the exemplary embodiment represented in FIG. 4b, smaller thickness d of tire bead 23 is achieved, by way of example, by an inner covering or inner liner 24 formed to be thinner in its material thickness as well as by an outer tire wall 25 formed to be thinner. Smaller thickness d of the rubber material between radially inner steel cords 16 and the radial inner side of tire bead 23 leads to a radial force on beat seat 9 of wheel rim 3 which is lower in comparison with tire bead 12 of pneumatic tire 13 according to the prior art (FIG. 1). Reduced rubber thickness d is dimensioned here in such a manner that the radial force exerted by each tire bead 23 of pneumatic tire 2 on corresponding bead seat 9 (FIG. 1), in the case of a pneumatic tire 2 filled with operating air pressure, is at least approximately 5% lower than in the case of a conventional pneumatic tire 13, represented in FIG. 4a, which can be conventionally assigned to previously determined wheel rim 3. At the same time, the reduction in radial thickness d of the stated rubber material between bead core 15 and the radial inner side of tire bead 23 is, however, also restricted at the bottom in such a manner that the radial force of tire bead 23 on bead seat 9 of tire rim 3 is at most approximately 25% lower than in the case of a conventional pneumatic tire 13, represented in FIG. 4a, which can conventionally be assigned to previously determined wheel rim 3.

Alternatively or additionally to changing radial thickness d of the rubber material between radially innermost steel cords 16 and the radial inner side of tire bead 23 represented in FIG. 4b, the rubber material can also be formed from a material with higher elasticity in order as a result to reduce the radial force on bead seat 9 of wheel rim 3 (FIG. 1) in the manner described above with the same effect.

The arrangement described above according to the invention comprising a pneumatic tire and a wheel rim which retains it for a vehicle, in particular motor vehicle, is not restricted to the embodiments disclosed herein, rather also encompasses further embodiments with the same action.

It should in particular be understood in this context that the radial force of the tire bead on its corresponding bead seat of the tire rim can also be determined indirectly via a bead unseating method which is well known and in the case of which a force can be determined which is to be applied in the axial direction of the tire/rim arrangement to be tested on the side wall of the pneumatic tire in order to push the tire bead formed on the side wall into the drop center of the wheel rim. There is a direct relationship between the force exerted radially by the tire bead of the pneumatic tire on the corresponding bead seat of the tire rim and the required axial bead unseating force determined by the bead unseating method.

The following standard bead unseating forces Fst are thus defined, for example, in the relevant known guidelines or norms established by industry standards-setting organizations (e.g. standard WDK 116, established by the Business Association of the German Rubber Industry) for different, conventional pneumatic tires (standard pneumatic tires) depending on the tire width:

| Tire width [mm] | Bead unseating force Fst [N] |
|---|---|
| 125-155 | 7000 |
| 155-205 | 9000 |
| 205-255 (and wider) | 11000 |

The following standard inner diameter Diw_st in mm of a bead core of a conventional pneumatic tire which can be assigned conventionally to the tire rim are likewise defined for a previously determined tire rim (standard tire rim) with a rim outer diameter Da in mm in accordance with ETRTO R9:

Diw_st=Da+3.5 mm (for single-ply tire constructions/mono ply)

Diw_st=Da+4.8 mm (for two-ply tire constructions/dual ply)

Standard number Nst of the steel cords used in the case of conventional pneumatic tires in the tire bead is dependent on the capacity index LI of the tire and on the special bead core configuration, i.e. the arrangement of the steel cords in the bead core, as specified below, wherein Nst is indicated below, by way of example, for two standard bead core configurations, namely for an arrangement of the steel cords in the bead core which is substantially rectangular as seen in cross-section as well as substantially hexagonal:

i LI≤80: Nst=16/5 (rectangular/hexagonal)

80≤LI≤90: Nst=20/7

90 ≤LI≤100: Nst=25/8

100≤LI≤110: Nst=30/10

110≤LI≤120: Nst=36/12

It is possible to calculate, on the basis of the following formula developed by the inventors, the desired magnitude (within the meaning of the present disclosure) of the radial force for the tire/rim arrangement as disclosed herein which is at least approximately 5% lower than in the case of a conventional pneumatic tire which can conventionally be assigned to the previously determined wheel rim and likewise preferably at most approximately 25% lower than in the case of a conventional pneumatic tire which can conventionally be assigned to the previously determined wheel rim, on the basis of a reduction in the axial bead unseating force (F) in relation to a standard bead unseating force (Fst) defined for a standards-meeting (meeting, that is, industry-recognized standards established by standards-setting organizations such as those named herein above) tire/rim combinations depending on desired parameters, for example, inner diameter of the bead core (Diw), number of steel cords in the bead core (N), and thickness (d) of the rubber material between the radially innermost steel cords and the radial inner side of the tire bead:

F=1000 N/mm*(Diw_st−Diw+d−dst)+N/Nst*Fst

wherein dst corresponds to a standard thickness of the rubber material between the radially innermost steel cords and the radial inner side of the tire bead of 2.5 mm.

For example, the following definition is produced for a mono-ply pneumatic tire with the dimensions 205/55 R16 91 H:

205 mm tire width=>Fst=11000 N

It should be assumed a radial force of the tire bead on the bead seat of the tire rim of approximately 2000 N arises in the case of an axial bead unseating force Fst of 11000 N, i.e. in this example the radial force is smaller than the axial bead unseating force approximately by the factor 5.5.

The following also arises from the dimensions of the pneumatic tire selected by way of example:

16″ tire diameter=>rim diameter in accordance with ETRTO R9: Da=405.6 mm

The standard inner diameter of bead core Diw_st is also determined from this:

Diw_st=405.6 mm+3.5 mm=409.1 mm

Standard thickness dst of the rubber material between the bead core and the radial inner side of the tire bead is set as mentioned above:

dst=2.5 mm

Standard number Nst of the steel cords in the bead core is produced from the capacity index LI and a rectangular bead core configuration assumed by way of example of the pneumatic tire selected above by way of example:

LI=91=>Nst=25

The radial force can then be set in the force range according to the invention with following parameters Diw, d and N selected by way of example in that parameters Diw, d and N are correspondingly selected:

$$Diw = 410 mm ; d = 2 mm ; N = 24$$

$$F = 1000 N \text{/} mm * ( Diw\_st - Diw + d - dst ) + N \text{/} Nst * Fst = 1000 N \text{/} mm * ( ( 409.1 mm - 410 mm ) + ( 2 mm - 2.5 mm ) ) + 24 / 25 * 11000 N = 9160 N$$

A radial force is produced from the previously determined axial bead unseating force of 9160 N with the factor identified above of 5.5 between the axial bead unseating force and the radial force:

9160 N/5.5=1665.45 N

In other words, by increasing the inner diameter of the bead core (Diw), and/or reducing the rubber thickness (d) between the radially innermost steel cords and the radial inner side of the tire bead, and/or reducing the number of steel cords in the tire bead (N) in comparison with the conventional pneumatic tire (standard pneumatic tire) which is conventionally assigned to the previously determined wheel rim (standard rim), the desired effect of reducing the radial force by the prescribed amount is achieved and as a result of this the transmission of structure-borne noise from the adapted pneumatic tire determined in a manner according to the invention to the wheel rim via the tire bead of the pneumatic tire and the bead seat of the wheel rim is significantly reduced as described herein.

A comparison of the radial force of the tire bead conventionally determined for the standard pneumatic tire selected by way of example herein by standard bead unseating force Fst of 11000 N on the corresponding bead seat of the tire rim of 2000 N (conversion by the factor of 5.5 determined above) with the reduced value, achieved in the manner according to the invention, of new bead unseating force F of 9160 N or after conversion with the factor 5.5 new radial force of 1665.45 N shows that the force of the tire/rim arrangement according to the invention in comparison with the force of the conventional tire/rim arrangement is reduced by approximately 335 N or 16.75% and thus lies within the preferred reduction range of approximately 5% to approximately 25%.

Particularly preferred minimum and maximum force values of the radial forces of a tire bead of a pneumatic tire which are reduced according to the invention in comparison with the standard/conventional radial forces as a function of the respective nominal tire width on the corresponding bead seat of a wheel rim, which form a tire/rim arrangement according to the invention, and satisfy the conditions disclosed herein, are indicated by way of example in the following table:

| | | Standard | Preferred reduced |
|---|---|---|---|
| | Standard bead | radial force | radial force |
| Tire width | unseating force Fst | (factor 5.5) | according to invention |
| [mm] | [N] | [N] | [N] |
| 125-155 | 7000 | 1273 | 1200-1000 |
| 155-205 | 9000 | 1636 | 1500-1200 |
| 205-255 | 11000 | 2000 | 1800-1500 |
| (and wider) | | | |

In a preferred embodiment, the tire/rim arrangement according to the invention is used as a vehicle wheel on a vehicle, in particular on a single-track or multi-track motor vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A pneumatic tire for use with a wheel rim having a bead seat with an outer diameter established by a standards-setting organization to mate with a conventional tire, the pneumatic tire having a bead of an inner diameter established by: a) determining a conventional radial force exerted by the bead of the conventional tire on the rim, and b) setting the inner diameter such that, when mounted on the rim the bead exerts on the bead seat a modified radial force at least 5% lower than the conventional radial force.

2. The tire as claimed in claim 1, wherein the inner diameter is further set such that the modified radial force is at most 25% lower than the conventional radial force.

3. The tire of claim 1, wherein the bead has a bead core comprising a modified number of cords, the modified number being lower than a second number of cords in a bead core of the bead of the conventional tire.

4. The tire of claim 1, wherein the bead has a bead core comprising a plurality of cords, at least one of the plurality of cords having a modified elasticity greater than a conventional elasticity of a plurality of cords of the conventional tire.

5. The tire of claim 1, wherein the bead has a bead core comprising a plurality of cords, and a rubber material disposed between a radially innermost of the cords and a radial inner side of the bead has a higher elasticity in comparison with a corresponding rubber material elacticity of the conventional tire.

6. The tire of claim 1, wherein the bead has a bead core comprising a plurality of cords, and a rubber material disposed between a radially innermost of the cords and a radial inner side of the bead has a smaller radial thickness in comparison with a corresponding rubber material radial thickness of the conventional tire.

7. A method of constructing a pneumatic tire, comprising:
determining a conventional radial force exerted by a bead of a standards-meeting tire on a standards-meeting wheel rim; and
constructing a modified tire having a bead inner diameter larger than a bead inner diameter of the standards-meeting tire by an amount to generate a modified radial force on the standards-meeting wheel rim that is at least 5% lower than the conventional radial force.

8. The method of claim 7, wherein the bead inner diameter is further set such that the modified radial force is at most 25% lower than the conventional radial force.

9. The method of claim 7, wherein the modified tire is constructed with a bead core comprising a modified number of cords, the modified number being lower than a conventional number of cords in a bead core of the standards-meeting tire.

10. The method of claim 7, wherein the modified tire is constructed with a bead core comprising a plurality of cords, at least one of the plurality of cords having a modified elasticity greater than a conventional elasticity of a plurality of cords of the standards-meeting tire.

11. The method of claim 7, wherein the modified tire is constructed with a bead core comprising a plurality of cords, and a rubber material disposed between a radially innermost of the cords and a radial inner side of the bead has a higher elasticity in comparison with a conventional rubber material elasticity of the standards-meeting tire.

12. The method of claim 7, wherein the modified tire is constructed with a bead core comprising a plurality of cords, and a rubber material disposed between a radially innermost of the cords and a radial inner side of the bead has a smaller radial thickness in comparison with a conventional rubber material radial thickness of the standards-meeting tire.

13. A method of designing a pneumatic tire, comprising:
determining, for a standards-meeting tire/rim combination, a conventional radial force exerted by a bead of the standards-meeting tire on the standards-meeting rim; and determining an increase in an inner diameter of the bead to yield a modified radial force on the standards-meeting rim that is at least 5% lower than the conventional force.

14. The method of claim 13, wherein the increase in the bead inner diameter is further determined such that the modified radial force is at most 25% lower than the conventional radial force.

15. The method of claim 13, wherein the pneumatic tire has a bead core comprising a plurality of cords, and the increase in the inner diameter of the bead is achieved by decreasing a number of cords in the plurality relative to a conventional number of cords in a bead core of the standards-meeting tire.

16. The method of claim 13, wherein the pneumatic tire has a bead core comprising a plurality of cords, and at least one of the plurality of cords have a modified elasticity greater than a conventional elasticity of a plurality of cords of the standards-meeting tire.

17. The method of claim 13, wherein the pneumatic tire has a bead core comprising a plurality of cords and a rubber material disposed between a radially innermost of the cords and a radial inner side of the bead, and the rubber material has a higher elasticity in comparison with a conventional rubber material elasticity of the standards-meeting tire.

18. The method of claim 13, wherein the pneumatic tire has a bead core comprising a plurality of cords and a rubber material disposed between a radially innermost of the cords and a radial inner side of the bead, and the rubber material has a smaller radial thickness in comparison with a conventional rubber material radial thickness of the standards-meeting tire.
